(19) United States
(12) Patent Application Publication
(10) Pub. No.: US 2017/0262427 A1
(43) Pub. Date: Sep. 14, 2017

(54) INFORMATION PROCESSING APPARATUS, INFORMATION PROCESSING METHOD, AND NON-TRANSITORY COMPUTER READABLE MEDIUM

(71) Applicant: FUJI XEROX CO., LTD., Tokyo (JP)

(72) Inventor: Shinji SHIMAMURA, Yokohama-shi (JP)

(73) Assignee: FUJI XEROX CO., LTD., Tokyo (JP)

(21) Appl. No.: 15/219,868

(22) Filed: Jul. 26, 2016

(30) Foreign Application Priority Data
Mar. 11, 2016 (JP) 2016-048186

(51) Int. Cl. G06F 17/27; G06F 17/28

(52) U.S. Cl. CPC G06F 17/2735; G06F 17/2854; G06F 17/2836

(57) ABSTRACT

An information processing apparatus includes an editing receiving unit and a proposal unit. The editing receiving unit receives editing contents with respect to translation results obtained by a translation engine performing translation using an editable translation dictionary which is editable by a user and an uneditable translation dictionary which is uneditable by a user and which is specialized for a specific field. The proposal unit proposes changing a parallel translation in the uneditable translation dictionary or the editable translation dictionary or changing selection of the uneditable translation dictionary or the editable translation dictionary, based on the uneditable translation dictionary and the editable translation dictionary that are used by the translation engine and the editing contents received by the editing receiving unit.

### CROSS-REFERENCE TO RELATED APPLICATIONS

This application is based on and claims priority under 35 USC 119 from Japanese Patent Application No. 2016-048186 filed Mar. 11, 2016.

### TECHNICAL FIELD

The present invention relates to an information processing apparatus, an information processing method, and a non-transitory computer readable medium.

### RELATED ART

In recent years, mechanical translation of translating an original document into another language using a computer has been widely used. In order to improve the quality of mechanical translation, a high-quality dictionary is required. That is, appropriate translations of words are required to be registered in a dictionary. In addition, in order to translate an original document in a certain specialized field, it is preferable to select and use a specialized dictionary in the specialized field. Further, in a case where results of mechanical translation include an inappropriate translation, work for correcting the translation is performed.

### SUMMARY

According to an aspect of the invention, art information processing apparatus includes an editing receiving unit and a proposal unit. The editing receiving unit receives editing contents with respect to translation results obtained by a translation engine performing translation using an editable translation dictionary which is editable by a user and an uneditable translation dictionary which is uneditable by a user and which is specialized for a specific field. The proposal unit proposes changing a parallel translation in the uneditable translation dictionary or the editable translation dictionary or changing selection of the uneditable translation dictionary or the editable translation dictionary, based on the uneditable translation dictionary and the editable translation dictionary that are used by the translation engine and the editing contents received by the editing receiving unit.

### BRIEF DESCRIPTION OF THE DRAWINGS

Exemplary embodiments of the present invention will be described in detailed based on the following figures, wherein:

FIG. 1 is a block diagram showing an information processing apparatus according to an exemplary embodiment of the invention;

FIG. 2 is a diagram showing a hardware configuration of a computer constituting the information processing apparatus in this exemplary embodiment;

FIG. 3 is a flow chart showing a proposal process in this exemplary embodiment;

FIG. 4 is a diagram showing an example of a data configuration of word translation results in this exemplary embodiment;

FIG. 5 is a diagram showing an example of a data configuration of a parallel translation setting candidate which is created from editing contents and a word translation result in this exemplary embodiment; and

FIG. 6 is a diagram showing an example of a data configuration of dictionary n-difference information, word translation results, and parallel translation dictionary correspondence information which is created from these pieces of information in this exemplary embodiment.

### DETAILED DESCRIPTION

Hereinafter, a preferable exemplary embodiment of the invention will be described with reference to the accompanying drawings.

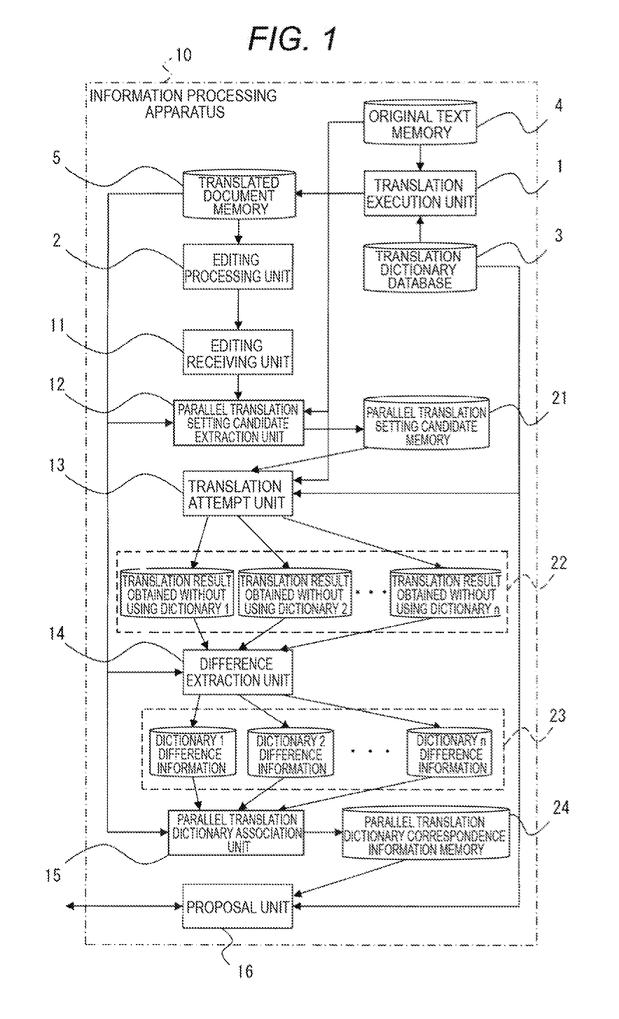

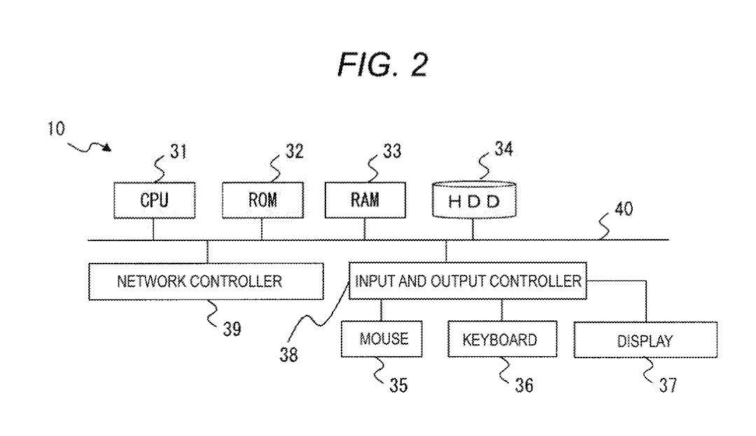

FIG. 1 is a block diagram showing an information processing apparatus according to an exemplary embodiment of the invention. In addition, FIG. 2 is a diagram showing a hardware configuration of a computer constituting an information processing apparatus 10 in this exemplary embodiment. In this exemplary embodiment, a computer constituting the information processing apparatus 10 can be realized by the existing general-purpose hardware configuration such as a personal computer (PC). That is, as shown in FIG. 2, the computer is configured such that an input and output controller 38 connecting a CPU 31, a ROM 32, a RAM 33, a hard disk drive (HDD) 34, a mouse 35 provided as an input unit, a keyboard 36, and a display 37 provided as a display device to each other and a network controller 39 provided as a communication unit are connected to an internal bus 40.

Referring back to FIG. 1, the information processing apparatus 10 in this exemplary embodiment includes a translation execution unit 1, an editing processing unit 2, a translation dictionary database (DB) 3, an original text memory 4, and a translated document memory 5. The translation dictionary database 3 stores a translation dictionary. The translation execution unit. is realized by a translation engine, and performs translation, that is, mechanical translation using the translation dictionary registered in the translation dictionary database 3. The original text memory 4 stores an original text (original document) which is a target for the translation. The translated document memory 5 stores translation results obtained by the translation engine, that is, a translated document which is created by the translation. In this exemplary embodiment, a description will be given of an example of a case where an original document (original text) written in Japanese is translated into English, but the original language of each of the original text and the translated document is not limited to this example. The editing processing unit 2 is realized by document creation software, and performs an editing process with respect to a translated document in accordance with a user's input.

Incidentally, the translation engine generally uses three types of translation dictionaries of a basic dictionary; a user dictionary, and a specialized dictionary during translation. The basic dictionary is a dictionary which is provided in the translation engine in advance. The user dictionary is an editable translation dictionary which is editable by a user and is configured such that a desired parallel translation can be set and registered therein. Naturally, cancelation can also he performed. Meanwhile, the wording “parallel translation” as used in this exemplary embodiment refers to a set in which words of different two languages are written in association with each other. A word on one side is a translated word of a word on the other side. The specialized dictionary is a dictionary in which sets of translated words specialized for a certain specific technical field are registered, and is an uneditable translation dictionary of which the registered contents cannot he edited by a user. In addition, what parallel translations are registered in each specialized dictionary is not disclosed. The translation engine performs translation using a specialized dictionary which is selected in advance, in addition to the basic dictionary and the user dictionary. Accordingly, a translation result may vary depending on the type of specialized dictionary to be selected.

The information processing apparatus 10 in this exemplary embodiment is characterized by proposes changing the selection of a parallel translation with respect to a specialized dictionary or a user dictionary which is to be used for translation by the translation engine so that a user can obtain an expected translation result. The components 1 to 5 are the existing components, while the information processing apparatus 10 is provided with the following components in this exemplary embodiment in order to realize the above-mentioned Characteristic.

That is, the information processing apparatus 10 in this exemplary embodiment further includes an editing receiving unit 11, a parallel translation setting candidate extraction unit 12, a translation attempt unit 13, a difference extraction unit 14, a parallel translation dictionary association unit 15, a proposal unit 16, a parallel translation setting candidate memory 21, a translation result memory 22, a difference information memory 23, and a parallel translation dictionary correspondence information memory 24. Meanwhile, components that are not used to describe this exemplary embodiment are not shown in FIG. 1.

The editing receiving unit 11 is an editing receiving unit that receives editing contents, obtained by the editing processing unit 2, with respect to a translated document. The parallel translation setting candidate extraction unit 12 extracts a parallel translation desired to be used to obtain a desired translated document, as a parallel translation setting candidate. The parallel translation includes a set of a word in an original text to be edited and editing contents (word after editing) for the work received by the editing receiving unit 11. The translation attempt unit 13 is realized by a translation engine, and a processing function provided is the same as that of the translation execution unit 1. Assuming that translation dictionaries other than a basic dictionary used for the translation execution unit 1 to create a translated document are referred to as “usage translation dictionaries”, the translation attempt unit 13 is different from the translation execution unit 1 in that translation is performed without using one translation dictionary among the usage translation dictionaries. The translation attempt unit 13 stores translation results obtained when performing translation without using one translation dictionary in the translation result memory 22. The difference extraction unit 14 extracts a difference between a translation result (translated document) obtained by the translation execution unit 1 using all of the usage translation dictionaries and each of the translation results (translated documents) obtained by the translation attempt unit 13 to thereby generate difference information, and stores the generated difference information in the difference information memory 23. The parallel translation dictionary association unit 15 associates a parallel translation of a set of a word (hereinafter, also referred to as the “original word”) which is included in an original text corresponding to the difference extracted by the difference extraction unit 14 and a translation result of the word, with a translation dictionary which is the cause of the formation of the parallel translation to thereby generate parallel translation dictionary correspondence information, and registers the generated information in the parallel translation dictionary correspondence information memory 24. The proposal unit 16 proposes changing the selection of a parallel translation with respect to a specialized dictionary or a user dictionary which is to be used for translation by the translation execution unit 1, based on the specialized dictionary and the user dictionary which are used by the translation execution unit 1 at the time of obtaining a translation result and editing contents received by the editing receiving unit 11.

Meanwhile, each piece of information registered in each of the memory 21 to 24 is created in the stage of a proposal process, and thus a description will be given together with a description of the process.

The components 1, 2, and 11 to 16 in the information processing apparatus 10 are realized by a cooperative operation between a computer constituting the information processing apparatus 10 and a program that operates by the CPU 31 mounted on the computer. In addition, each of the memories 3 to 5 and 21 to 24 is realized by the HDD 34 mounted on the information processing apparatus 10. Alternatively, the RAM 33 or an external memory may be used through a network.

In addition, a program used in this exemplary embodiment can not only be provided by a communication unit but also be provided by being stored in a computer-readable recording medium such as a CD-ROM or a USB memory. The communication unit or the program provided from the recording medium is installed in the computer, and the CPU 31 of the computer sequentially executes programs, thereby realizing various processes.

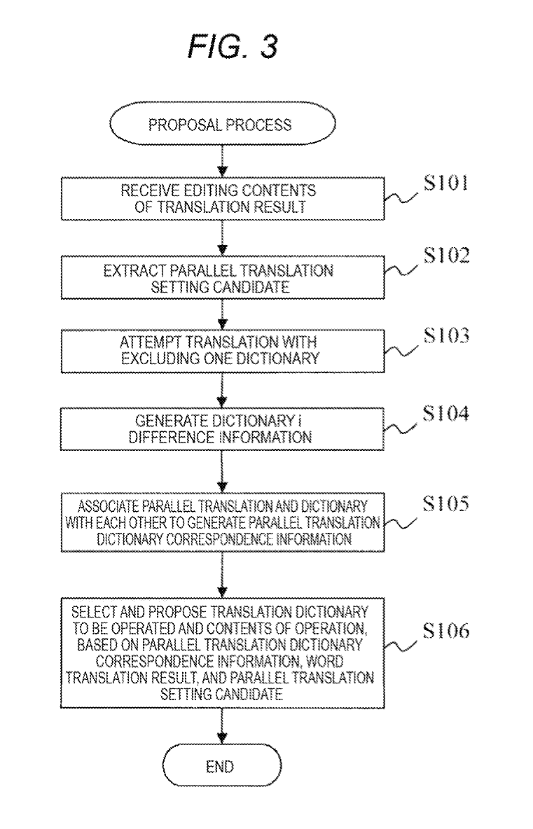

Next, a proposal process in this exemplary embodiment will be described with reference to a flow chart shown in FIG. 3.

First, it is assumed that a translated document of an original document (original text) has been already created by the translation execution unit 1. Meanwhile, the information processing apparatus 10 ascertains a specialized dictionary Which is selected during translation performed by the translation execution unit 1.

A user performs editing, such as the change of a word in a translated document, using an editing function of the editing processing unit 2. For example, assuming that an original document is a report related to mathematics, it is expected that “ [symbol] ” (“Gyo-Retsu” which is Japanese-language term to be used in referring at least to “matrix” and “line”) included in the original document is translated into “matrix”. However, it is assumed that “ [symbol] ” is translated into “line” because a dictionary of mathematics has not been selected as a specialized dictionary to be used. In this case, the user deletes “line” using an editing function and performs editing. for inputting “matrix”. The editing receiving unit 14 pairs the contents before and after the editing and receives the paired contents as editing contents (step 101).

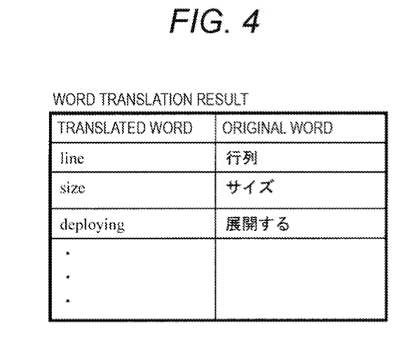

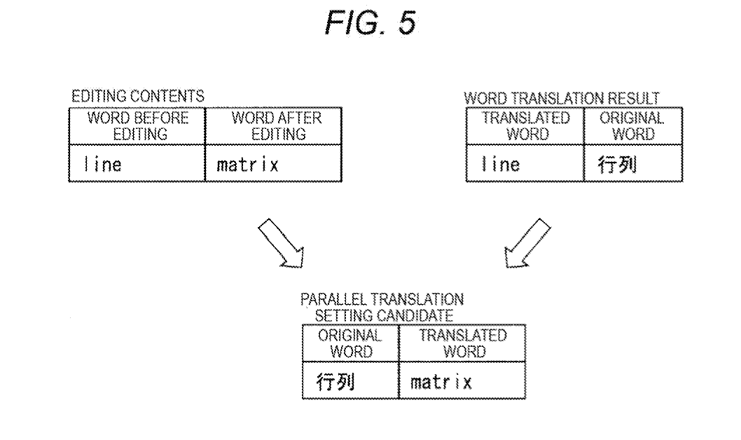

Incidentally, translation results obtained by a translation engine include word translation results in which words (original words) included in an original text and translation results (translation words) of the words are associated with each other as shown in FIG. 4. In addition, the original text may be included. The parallel translation setting candidate extraction unit 12 associates the word translation results with the editing contents received by the editing receiving unit 11 according to words included in the translated document to thereby extract a parallel translation setting candidate (step 102). Although an example of the association is shown in FIG. 5, the association is performed by a translation word (word before editing) of “line” in the above-mentioned example, and thus a word which is expected to be translated (word which is input by the user, and hereinafter also referred to as “word after editing”) is associated with the original word and as a translation word, thereby creating a parallel translation setting candidate.

Incidentally, the user expects that “ [symbol] ” is translated into “matrix”. However, “ [symbol] ” is actually translated into “line”. In this exemplary embodiment, subsequently, a translation dictionary which is the cause of “ [symbol] ” being translated into “line” is specified.

First, the translation attempt unit 13 specifies all of the translation dictionaries (hereinafter, also referred to as “usage translation dictionaries”) which are used during translation performed by the translation execution unit 1. Assuming that the specified n usage translation dictionaries are a dictionary 1, a dictionary 2, . . . , and a dictionary n, the translation execution unit 1 performs translation using all of the dictionaries 1 to n. On the other hand the translation attempt unit 13 attempts translation without using one translation dictionary of the usage translation dictionaries (step 103). This is repeated by the number of usage translation dictionaries. Specifically, the translation attempt unit 13 performs translation with sets of dictionaries of (the dictionaries 2 to (the dictionary 1 and the dictionaries 3 to a), and (the dictionaries 1 and 2 and the dictionaries 4 to n). In this manner, the translation attempt unit 13 creates n translation results each obtained without using a dictionary i (i=1 to n) and stores the results in the translation result memory 22.

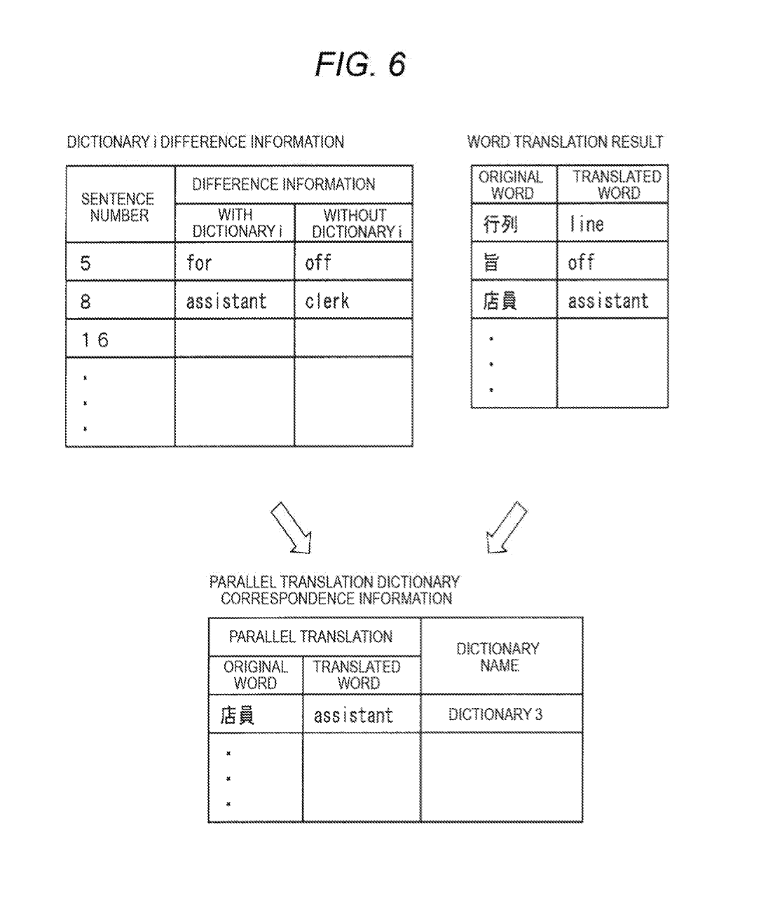

Subsequently, the difference extraction unit 14 generates n pieces of dictionary i (i=1 to n) difference information based on the corresponding translation results obtained without using the dictionary i, as shown in FIG. 6 (step 104). Here, “with dictionary i” included in difference information in the dictionary i difference information is a translated word when translation is performed using the dictionary i, and is a translated word obtained through translation performed by the translation execution unit 1. On the other hand, “without dictionary i” is a translated word when translation is performed by the translation attempt unit 13 without using the dictionary i, in this manner, in a case where there are two translated words for one original word, the difference extraction unit 14 extracts the translated words thereof, forms difference information therebetween, and stores the formed information in the difference information memory 23 as dictionary n difference information in association with a sentence number. Meanwhile, the sentence number is an identification number of a sentence in an original text including a word translated into different translated words. Specifically, for example, in a case of i=3 in FIG. 6, it means that an original word of “ [symbol] ” (“Ten-In” which is Japanese language-term to be used in referring at least to “assistant” and “clerk”) is translated into “assistant” in translation performed by the translation execution unit 1 using all usage translation dictionaries, but is translated into “clerk” in translation performed by the translation attempt unit 13 without using the dictionary 3. Thereby, a parallel translation of a set of “ [symbol] ” and “assistant” is set in the dictionary 3, and thus a translation dictionary which is the cause of the translation of “ [symbol] ” into “assistant” can be specified as the dictionary 3.

In this manner, when a pieces of dictionary i difference information are created, the parallel translation dictionary association unit 15 sets a set of the original word for which difference information is created and an inappropriate translated word (word before editing) of the original word as a parallel translation, associates a dictionary name of a translation dictionary in which the parallel translation is set with the parallel translation to thereby create parallel translation dictionary correspondence information, and registers the created information in the parallel translation dictionary correspondence information memory 24 (step 105). An example of the parallel translation dictionary correspondence information generated in this manner is shown in FIG. 6.

Subsequently, in this exemplary embodiment, the proposal unit 16 selects and presents proposals of different contents according to whether parallel translation (according to the above-mentioned example, a parallel translation of “ [symbol] ” and “line”) of the original word and a user's undesired translated word is included in parallel translation dictionary correspondence information (step 106). Meanwhile, since the user desires to translate the original word “ [symbol] ” into “matrix”, a description will be given by straightforwardly referring to translation into “line” performed by a translation engine as “mistranslation” here for convenience of description.

<Proposal 1> In a case where correspondence dictionary correspondence information includes a parallel translation of a set of “ [symbol] ” and line which is the cause of mistranslation and the parallel translation is associated with a specialized dictionary, the proposal unit 16 specifies the specialized dictionary as an objected to be operated and proposes an operation of excluding the specified specialized dictionary from dictionaries used by a translation engine, that is, an operation of canceling the selection of the specialized dictionary. This is because “ [symbol] ” is mistranslated into “line” due to a specialized dictionary, including a parallel translation of a set of “ [symbol] ” and “line”, being selected as an object to be used.

<Proposal 2> In a case where correspondence dictionary correspondence information includes a parallel translation of a set of “ [symbol] ” and “line” which is the cause of mistranslation and the parallel translation is associated with a uses dictionary, the proposal unit 16 specifies the user dictionary as an object to be operated and proposes an operation of changing the selection of the parallel translation of the user dictionary to a parallel translation included in a parallel translation setting candidate. In other words, since the mistranslation is caused by a parallel translation of a set of “ [symbol] ” and “line” being registered in the user dictionary, the parallel translation which is the cause of the mistranslation may be selectively changed to a parallel translation (parallel translation of a set of “ [symbol] ” and “matrix”) which is included in a parallel translation setting candidate on which a user's editing is reflected on.

<Proposal 3> In a case where correspondence dictionary correspondence information does not include a parallel translation of a set of “ [symbol] ” and “line” which is the cause of mistranslation and a parallel translation included in a parallel translation setting candidate and a parallel translation of a set of “ [symbol] ” and “matrix” according to the above-mentioned example are included in any specialized dictionary, the proposal unit 16 specifies a specialized dictionary including the parallel translation as an object to be operated and proposes an operation of including the specified specialized dictionary in a dictionary used by a translation engine, that is, an operation of selecting the specialized dictionary. The translation execution unit 1 is not limited to using all of the specialized dictionaries registered m the translation dictionary database 3. When only the specialized dictionary used by the translation execution unit 1 is used, “ [symbol] ” is mistranslated into “line” as described above. Consequently, it is confirmed whether or not a parallel translation of a set of “ [symbol] ” and “matrix” is registered in any specialized dictionary which is registered in the translation dictionary database 3 and has not been used by the translation execution unit 1. When the parallel translation is registered in the specialized dictionary, “ [symbol] ” is translated into “matrix” instead of “line” by using the specialized dictionary.

As described above, a parallel translation registered in a specialized dictionary is not disclosed. Accordingly, the proposal unit 16 starts up a translation engine using, for example, the translation attempt unit 13 to make the translation engine translate the original text. At this time, the proposal unit selects any specialized dictionary that has not been used by the translation execution unit 1. If “ [symbol] ” is translated into “matrix” a parallel translation of a set of “ [symbol] ” and “matrix” is registered in the specialized dictionary used at that time. In this manner, the proposal unit 16 retrieves a specialized dictionary in which a parallel translation of a set of “ [symbol] ” and “matrix” is registered.

As described at first, in this exemplary embodiment, “ [symbol] ” is mistranslated into “line” due to a dictionary of mathematics not being used. Accordingly, it is considered that an example in this exemplary embodiment corresponds to proposal 3 and proposes to select a dictionary of mathematics.

<Proposal 4> In a case where correspondence dictionary correspondence information does not include a parallel translation of a set of “ [symbol] ” and “line” which is the cause of mistranslation and a parallel translation included in a parallel translation setting candidate, that is, a parallel translation of a set of “ [symbol] ” and “matrix” according to the above-mentioned example is not registered in any specialized dictionary when retrieval described in proposal 3 mentioned above is performed, the proposal unit 16 specifies a user dictionary as an object to be operated and proposes an operation of adding a parallel translation setting candidate to the user dictionary. In other words, since a parallel translation of a set of “ [symbol] ” and “matrix” is not registered in all of the specialized dictionaries inclusive of the user dictionary, a parallel translation included in the parallel translation setting candidate, that is, the parallel translation of the set of “ [symbol] ” and “matrix” may be set and registered in the user dictionary.

As described above, the proposal unit 16 selects and proposes a translation dictionary to be operated and contents of an operation with respect to the translation dictionary. Meanwhile, a proposal destination is generally a user who creates an original document, but does not need to be limited thereto. Various proposal methods such as notice given to a user through an e-mail can be considered, but a notification method does not need to be particularly limited.

In this exemplary embodiment, the above-mentioned four proposals are described as contents of proposal. Regarding the proposal, plural proposals may be appropriately combined with each other instead of selecting any one proposal. For example, the proposal 1 proposes an operation of canceling a specialized dictionary. However, the retrieval of a specialized. dictionary described in the proposal 3 may be performed rather than simply performing the selection and cancellation, and the proposal of a specialized dictionary to be selected may be collectively performed.

According to this exemplary embodiment, the change of selection of a specialized dictionary to be used or a user dictionary is proposed to a user in this manner.

Meanwhile, in the above description, a flow of the proposal process shown in FIG. 3 is described by taking an example in which the original word of “ [symbol] ” included in the original text is mistranslated into “line”. Here, the processes of steps 103 to 105 are performed in order to finally obtain parallel translation dictionary correspondence information. The parallel translation dictionary correspondence information is common information even in a case where there are plural mistranslated parallel translations. Accordingly, in a case where the parallel translation dictionary correspondence information is held by the parallel translation dictionary correspondence information memory 24 even when plural words are edited in a translated document, it is not necessary to repeatedly perform the processes (steps 103 to 105) for obtaining the parallel translation dictionary correspondence information every time a translation word is translated.

In addition, the information processing apparatus 10 in this exemplary embodiment can also acquire and process results of translation performed by other computers. In other words, the components 1 to 5 may be provided on another computer. However, in this case, the information processing apparatus 10 requires a unit that acquires an original text and a translated document. In addition, the information processing apparatus is requited to have a translation dictionary database having the same configuration as that of a translation dictionary database of another computer, or it is necessary to make a translation dictionary database of another computer have access to a translation engine realizing the translation attempt unit 13.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
an editing receiving unit that receives editing contents with respect to translation results obtained by a translation engine performing translation using an editable translation dictionary which is editable by a user and an uneditable translation dictionary which is uneditable by a user and which is specialized for a specific field; and
a proposal unit that proposes changing a parallel translation in the uneditable translation dictionary or the editable translation dictionary or changing selection of the uneditable translation dictionary or the editable translation dictionary, based on the uneditable translation dictionary and the editable translation dictionary that are used by the translation engine and the editing contents received by the editing receiving unit.

2. The information processing apparatus according to claim 1, further comprising: an extraction unit that extracts editing contents with respect to a word in an original text to be edited.

3. The information processing apparatus according to claim 1, wherein in a case where a word included in an original text to be edited and a translation result with respect to the word are registered in any uneditable translation dictionary, the proposal unit proposes allowing the translation engine not to use the uneditable translation dictionary.

4. The information processing apparatus according to claim 2, wherein in a case where a word in an original text to be edited and a translation result with respect to the word are not registered in any translation dictionary used by the translation engine, the proposal unit proposes using the uneditable translation dictionary in which a parallel translation extracted by the extraction unit is registered.

5. The information processing apparatus according to claim 2, wherein in a case where a word in an original text to be edited and a translation result with respect to the word are registered in the editable translation dictionary, the proposal unit proposes changing the parallel translation registered in the editable translation dictionary to the editing contents extracted by the extraction unit.

6. The information processing apparatus according to claim 2, wherein in a case where a word in an original text to be edited and a translation result with respect to the word are not registered in any translation dictionary used by the translation engine and a case where the uneditable translation dictionary having the editing contents, extracted by the extraction unit, registered therein is not present, the proposal unit proposes registering the editing contents in the editable translation dictionary.

7. A non-transitory computer readable medium storing a program causing a computer to function as:
an editing receiving unit that receives editing contents with respect to translation results obtained by a translation engine performing translation using an editable translation dictionary which is editable by a user and an uneditable translation dictionary which is uneditable by a user and which is specialized for a specific field; and
a proposal unit that proposes changing a parallel translation in the uneditable translation dictionary or the editable translation dictionary or changing selection of the uneditable translation dictionary or the editable translation dictionary, based on the uneditable translation dictionary and the editable translation dictionary that are used by the translation engine and the editing contents received by the editing receiving unit.

8. An information processing method comprising:
receiving editing contents with respect to translation results obtained by a translation engine performing translation using an editable translation dictionary which is editable by a user and an uneditable translation dictionary which is uneditable by a user and which is specialized for a specific field; and
proposing changing a parallel translation in the uneditable translation dictionary or the editable translation dictionary or changing selection of the uneditable translation dictionary or the editable translation dictionary, based on the uneditable translation dictionary and the editable translation dictionary that are used by the translation engine and the received editing contents.
